(19) United States
(12) Patent Application Publication
(10) Pub. No.: US 2007/0250549 A1
(43) Pub. Date: Oct. 25, 2007

(54) Updating of Objects in Object-Based Control Systems

(75) Inventors: Mikael Meyer, Lund (SE); Johan Andersson, Vasteras (SE); Thomas Pauly, Vasteras (SE)

Correspondence Address: MYERS BIGEL SIBLEY & SAJOVEC, PO BOX 37428, RALEIGH, NC, 27627, US

(73) Assignee: ABB AB

(21) Appl. No.: 11/738,726

(22) Filed: Apr. 23, 2007

(30) Foreign Application Priority Data
Apr. 24, 2006 (SE) 0600894-0

(51) Int. Cl. G06F 17/30

(52) U.S. Cl. 707/203

(57) ABSTRACT

Embodiments of the invention are directed towards providing safe updating of objects in a computerized object-based system for process and manufacturing control. Some methods in some embodiments of methods may include providing a production environment within the system comprising operative versions of computer objects and at least one related engineering environment isolated from the production environment. Some embodiments of such methods may also include importing versions of objects to the engineering environment from a related environment, allowing a group of system-modifying users to modify the imported objects for creating modified versions of these objects and barring other users from modifying the imported objects, and exporting objects from the engineering environment to a related environment, where the exporting involves replacing current versions of objects in the related environment with modified versions for making the modified versions current versions.

### CROSS-REFERENCE TO RELATED APPLICATIONS

This U.S. non-provisional patent application claims priority under 35 U.S.C. §119 to Swedish Patent Application 0600894-0 filed on Apr. 24, 2006, the entire contents of which are hereby incorporated by reference.

### TECHNICAL FIELD OF THE INVENTION

The present invention relates to the field of computer-based systems for process and manufacturing control. The invention more particularly relates to methods, object updating devices, object-based computerized systems, and computer program products configured to manipulate objects in object-based control system.

### DESCRIPTION OF RELATED ART

Object-based computerized systems are known to be used for controlling operations in manufacturing and process industries, such as chemical plants, oil refineries, pulp and paper mills, steel mills, etc.

Existing systems include methods for integration of many and various types of applications in a computerized system. In some systems, real world objects may be represented as “composite objects.” Different facets of a real world object, such as its physical location, the current stage in a process, a control function, an operator interaction, a simulation model, some documentation about the object, etc., may each be described as different aspects of the composite object. A composite object may be a container for one or more such aspects. Thus, a composite object may not be an object in the traditional meaning of object-oriented systems, but rather a container of references to such traditional objects, which implement the different aspects. Each aspect or group of aspects may be implemented by an independent software application, which may provide its functionality through a set of interfaces that are accessible through the composite object. Another software application can thus query a composite object for a function associated with one of its aspects, and as a result may obtain, through the composite object, a reference to the interface that implements the function.

Systems that use containers and aspects in a system for process of manufacturing control keep evolving and changing to include new functions and improve already existing functions. Thus, a computerized system for process and manufacturing control may not be a final product that is produced, delivered and then never changed. There may always be a need for improvements and modifications. At the same time it is important that a process being controlled is not stopped when changes are being made. Thus, it may be important that changes are provided in a safe and contained way.

A traditional way of updating systems is to keep two complete separate systems, where one is an active production system used for controlling the process and the other is an engineering system, which is being updated. When updating is finished, the production system is replaced with the updated system, which is then used in the process control. This may be costly, especially when limited changes are to be made that only involve a limited number of objects, since a duplicate of an entire system is created just to accommodate changes in a limited number of object.

In source control systems, like RCS, SCCS, Visual Source Safe, ClearCase etc., it is also known that a file may be checked out when it needs to be changed. The file can then be edited and saved multiple times. When the changes are completed, an approved version of the file may be checked in.

### SUMMARY OF THE INVENTION

Embodiments of the present invention may provide the ability to perform changes to an object-based computerized system for process and manufacturing control in a safe and contained way, without disturbing ongoing production. Some embodiments provide methods of updating objects in an object-based computerized system. Such methods may include providing a related environment within the system comprising operative versions of computer objects, where at least some of the objects are used for control of real world objects in the process, providing at least one engineering environment within the system, the engineering environment being isolated from the related environment and receiving a request from a system-modifying user in a group of system-modifying users associated with the at least one engineering environment, to import selected versions of at least some objects to the at least one engineering environment from the related environment. Embodiments of such methods may also include importing the selected versions to the at least one engineering environment, allowing the group to modify the imported objects for creating modified versions of these objects and barring other users from modifying the imported objects, receiving a request from a system-modifying user of the group to export objects of the at least one engineering environment to the related environment after modification of the imported objects is finished, and exporting objects to the related environment responsive to the request, wherein the exporting the objects includes replacing current versions of objects in the related environment with modified versions from the at least one engineering environment, for making the modified versions the current versions.

In some embodiments, methods may include allowing the group to modify the imported objects for creating modified versions of these objects and barring other users from modifying the imported objects, receiving a request, from a system-modifying user of the group, to export objects of the at least one engineering environment to a related environment after modification of the imported objects is finished, and exporting objects to the related environment according to the request, where exporting objects involves replacing current versions of objects in the related environment with modified versions from the at least one engineering environment, for making the modified versions the current versions.

Some embodiments of the present invention may also provide an object updating device that updates objects in an object-based computerized system that is configured to control real world objects. In some embodiments, the device may be configured to provide a production environment within the system comprising operative versions of computer objects wherein at least some of the objects are used for control of real world objects in the process, provide at least one engineering environment within the system, wherein the engineering environment is isolated from the production environment, and receive a request from a system-modifying user in a group of system-modifying users associated with the at least one engineering environment to import selected versions of at least some objects to the at least one engineering environment from a related environment. Such embodiments may further be configured to import the selected versions to the at least one engineering environment, wherein the group is allowed to modify the imported objects for creating modified versions of these objects and other users are barred from modifying the imported objects, receive a request from a system-modifying user of the group to export objects of the at least one engineering environment to a related environment after modification of the imported objects is finished, and export objects to the related environment according to the request, wherein exporting the objects includes replacing current versions of the objects in the related environment with modified versions from the at least one engineering environment, for making the modified versions the current versions.

Embodiments of the present invention may provide an object-based computerized system for process and manufacturing control configured to control real world objects. Such systems may include at least one server and an object updating device configured to allow safe updating of objects being arranged to provide a production environment on at least one of the servers, the device comprising operative versions of computer objects wherein at least some are used for control of real world objects in the process.

In some embodiments, the object updating device may be further configured to provide at least one engineering environment on the at least one of the servers, wherein the engineering environment is isolated from the production environment, in order to provide a number of related environments including the production environment and all engineering environments, receive a request, from a system-modifying user in a group of system-modifying users associated with an at least one engineering environment, to import versions of at least some objects to the engineering environment from a related environment, and wherein the group includes at least one system-modifying user, import the selected versions to the at least one engineering environment. In some embodiments, the group is allowed to modify the imported objects for creating modified versions of these objects and other users are barred from modifying the imported objects, receive a request, from a system-modifying user of the group, to export objects of the at least one engineering environment to a related environment after modification of the imported objects is finished, and export objects to the related environment according to the request, wherein exporting comprises replacing current versions of objects in the related environment with modified versions from the at least one engineering environment, for making the modified versions current versions.

Embodiments of the present invention may also provide a computer program product configured to allow safe updating of objects in an object-based computerized system for process and manufacturing control configured to control real world objects. In such embodiments the computer program product may include computer program code to make, when the code is loaded into the at least one computer, the at least one computer provide a production environment within the system including operative versions of computer objects.

In some embodiments, at least some are used for control of real world objects in the process, provide at least one engineering environment within the system, wherein the engineering environment is isolated from the production environment, in order to provide a number of related environments including the production environment and all engineering environments.

In some embodiments, a request may be received from a system-modifying user in a group of system-modifying users associated with an at least one engineering environment, to import versions of at least some objects to the engineering environment from a related environment, wherein the group includes at least one system-modifying user. The at least one computer may be further configured to import the selected versions to the at least one engineering environment, wherein the group is allowed to modify the imported objects for creating modified versions of the objects and other users are barred from modifying the imported objects.

The at least one computer may be further configured to receive a request, from a system-modifying user of the group, to export objects of the at least one engineering environment to a related environment after modification of the imported objects is finished, and export objects to the related environment according to the request, wherein exporting comprises replacing current versions of objects in the related environment with modified versions from the at least one engineering environment, configured to make the modified versions the current versions.

Some embodiments of the present invention may provide updating of objects in a safe and/or contained way that may not disturb the process. Some embodiments may further allow an engineering environment to be small, so that it may only include the objects that need to be changed and/or are influenced by changes. There may thus be no need for copying all the objects of the production environment. In this manner, the additional system capacity such as the memory space needed for the engineering environments, can be kept small.

A system for process and manufacturing control according to some embodiments may be applicable to systems for controlling all types of processes including, for example, production and manufacturing processes and physical and/or chemical processes.

### BRIEF DESCRIPTION OF THE DRAWINGS

The present invention will now be described in more detail in relation to the enclosed drawings.

FIG. 1 schematically shows a computerized system for process and manufacturing control according to some embodiments of the present invention.

FIG. 2 shows a block schematic of a first server where two computer objects are provided in the form of a container and an aspect linked to the container together with a table for locating the aspect, as well as a second server comprising a client application communicating with the first server according to some embodiments of the present invention.

FIG. 3 shows a block schematic of a system including an object updating device, a production environment and two engineering environments according to some embodiments of the present invention.

FIG. 4 shows a block schematic of computer objects in a system according to some embodiments of the present invention, where different versions of aspects of a container are shown, as well as the environments they belong to.

FIG. 5, is a flow chart illustrating methods and/or systems according to some embodiments of the present invention.

FIG. 6 outlines a structure of hierarchical object according to some embodiments of the present invention.

FIG. 7 schematically shows a computer program product in the form of a CD ROM disc comprising computer program code for carrying out some embodiments of the present invention.

### DETAILED DESCRIPTION OF EMBODIMENTS

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the term “comprising” or “comprises” is open-ended, and includes one or more stated features, integers, elements, steps, components or functions but does not preclude the presence or addition of one or more other features, integers, elements, steps, components, functions or groups thereof.

As used herein, the term “and/or” includes any and all combinations of one or more of the associated listed items.

As used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Furthermore, “coupled” or “connected” as used herein may include wirelessly coupled or connected.

Well-known functions or constructions may not be described in detail for brevity and/or clarity.

The present invention may be embodied as methods, systems, and/or computer program products. Accordingly, the present invention may be embodied in hardware and/or in software (including firmware, resident software, micro-code, etc.), which may be generally referred to herein as a “circuit” or “module”. Furthermore, the present invention may take the form of a computer program product-on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

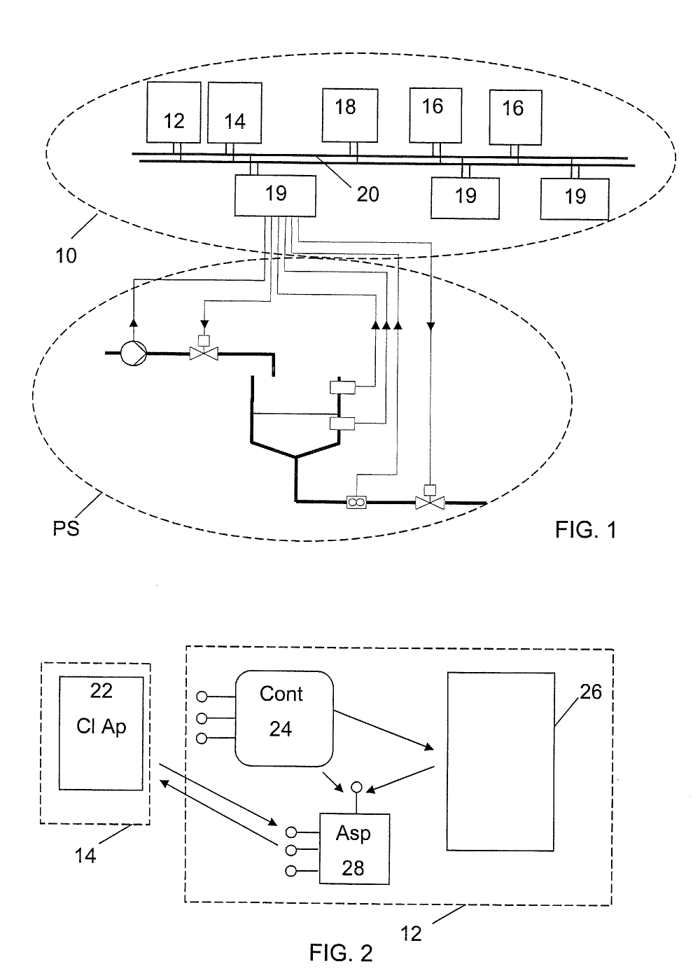

Reference is now made to FIG. 1, which schematically shows a first system for process and manufacturing control 10 according to some embodiments of the present invention. The system 10 is typically an object-based computerized system for controlling a process or part of a process. Typical processes may include electrical power generation and supply process, water purification and distribution processes, oil and gas production and distribution processes, petrochemical, chemical, pharmaceutical and food processes, and pulp and paper production processes, among others. These are just some examples of processes where the system can be applied. In FIG. 1, one exemplifying section PS of such a process is shown, although many other processes exist. In some circumstances, a process may include one or more controllers having some local software for controlling one or more real world objects in the process. The real world objects may be different entities that influence the technical process, like such things as a pump, a motor, a valve, etc., or a more abstract object such as a purchase order, production batch, etc. A process, or a part of a process, may be controlled via a server. In some embodiments, the server may be configured to communicate with a controller for providing control of a process. In some embodiments, the process may be monitored through an operator terminal, which may communicate with the server.

The system 10 may include an operator terminal 18, a first server 12 that includes computer objects for providing control of the process, a second server 14 that includes an application configured to control the process via objects in the first server 12, two engineering terminals 16, and multiple controllers 19 (Process Controller or Programmable Logic Controller PLC) all interconnected via a bus 20 for providing control in the system 10. A controller 19 may then be connected to one or more real world objects. By way of example, one of the controllers 19 is shown as being connected to a process section PS, which includes an inlet pipe leading to a tank and an outlet pipe leaving the tank. A pump is provided that pumps fluid into the first pipe as well as a first valve. Two level sensors are provided in the tank and a flow meter and a second valve is provided in the outlet pipe. All these elements are real world objects. The controller 19 receives control input values from the pump and level sensors and regulates the fluid level in the tank based on these control input values by controlling the first valve. The controller 19 also receives control input values from the flow meter and controls the second valve for regulating the output fluid flow. These entities are non-limiting examples of real world objects. As mentioned above, these real world objects, as well as other real world objects, may be controlled by computer objects provided in the first server. The system and the process section shown in FIG. 1 are presented merely by way of example and are not intended to limit the scope of the invention in any way. It should be realized that some embodiments may include more or fewer controllers, several different operator terminals, several different engineering terminals and/or several different servers. In the case of a small system, in some embodiments all server functionality and operator terminal functionality may exist in the same physical computer.

According to some embodiments of the present invention, the computer objects may be grouped in a specific manner. In order to control the real world objects of a process, containers may be used, such that there is one container for each real world object. FIG. 2 shows a block schematic of the second server 14 including a client application 22 and the first server 12 including a container Cont 24, an aspect Asp 28 and an aspect lookup table 26. It should be realized that the client application 22 need not be provided in the second server 14. For example, in some embodiments, the client application 22 may be provided in an operator terminal of the first system or in the first server 12.

In some embodiments of the invention, the container 24 may be a so-called COM object having a number of interfaces. For example, three interfaces are shown in FIG. 2. More information about COM objects may for instance be found in the Microsoft MSDN Online Library on a web site maintained by, for example, Microsoft. Additional information about COM objects may also be found in, for example, an article in Dr. Dobbs Journal December 1994 entitled The Component Object Model: Technical Overview.

Through these interfaces, the client application 22 can invoke a function that is related to an aspect that is held by the container 24. The client application 22 does this by querying the container 24 for an interface to this function, without knowing the identity of the application that implements the function for which it is seeking an interface. If the container 24 has an aspect that supports the interface, then a reference to the interface may be returned as some form of pointer to where that interface may be found.

The container Cont 24 may hold a number of aspects, of which one Asp 28 is shown in FIG. 2. Each aspect, which in some embodiments is also provided as a COM object, is related to the real world object. An aspect may represent one facet of the real world object, and may be responsible for all operations on that facet of the object and its data. Thus, in the case of a pump, for example, one aspect could represent a physical location, another aspect could represent a blue print diagram of the pump, another aspect could represent a security descriptor for the pump, another aspect could represent a control for an operation of the pump and yet another aspect could represent documentation about the pump. The aspect that represents the facet may have an association to a function of an application that can, referring to the above example, display the blue-print diagram, or control the operation of the pump.

The container furthermore may have access to an aspect lookup table 26, through which it may locate an aspect.

Thus, the client application 22, when needing to access a facet of the real world object, connects to the container 24 and requests an interface associated with the facet. The container then locates an aspect 28 associated with the facet via the aspect table 26, interrogates the aspect regarding its interfaces, receives information of an interface and returns the interface, through which the client application may connect to the aspect for retrieving data, control the real world object, etc.

What has been described above is a way that containers and aspects function when they are provided in a system. It should however be realized that objects need not be grouped into containers and aspects, but that any object structure can be used.

In a system of the above described type, it may be beneficial to be able to upgrade the system, which may normally be done by providing new versions of computer objects and in the structure of the example above, new versions of aspects. Thus, system-modifying users, may need to be working on objects as well. However, it may be beneficial not to stop or disturb the process control while working on the objects. Some embodiments of the present invention may provide such updating in a safe, contained and controlled way.

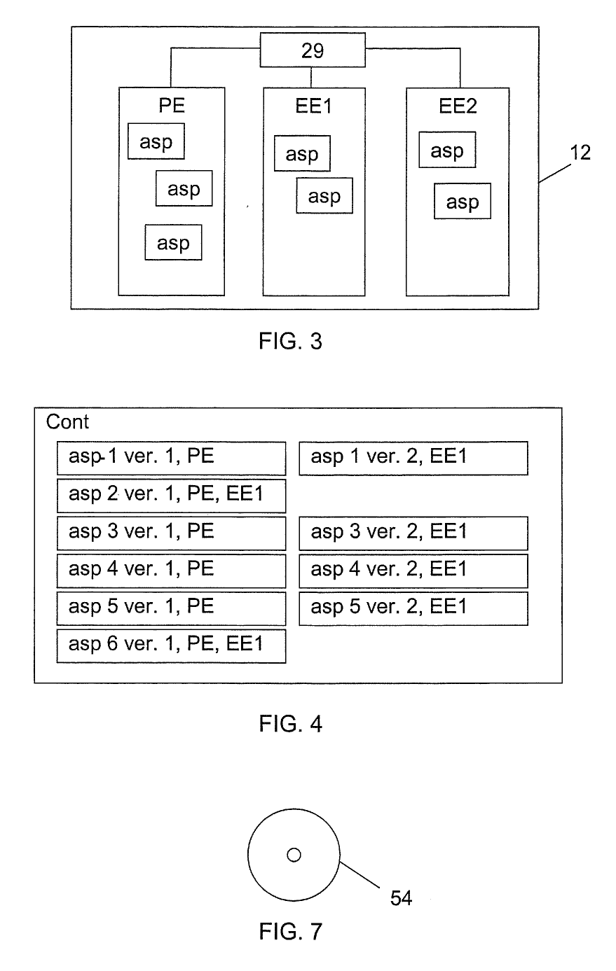

Some embodiments according to the present invention will now be described in relation to FIG. 1 together with FIGS. 3, 4 and 5. FIG. 3 shows a block schematic of the first server 14, where there is an object updating device 29 connected to three different environments that have been created. The three environments include a production environment PE, a at least one engineering environment EE1 and a second engineering environment EE2. In each environment there may be provided different objects in the form of containers and aspects asp. An environment may be a logical area for a number of objects where different sets of rules apply for different system users. FIG. 4 generally outlines a structure of providing different versions of aspects of a container Cont provided in the system and FIG. 5 shows a flow chart illustrating methods and/or systems according to some embodiments of the present invention.

When a need for an upgrading of at least some of the computer objects in the first server 12 of the system 10 arises, a production environment PE may be provided, step 30. In some embodiments, the production environment PE is the environment where the process control may be applied. In the production environment PE, original operative versions of objects may be provided, i.e. among others the objects used in the sharp real life control of the real world objects of the process. The process control may be performed in the way described above regarding FIG. 2. As updating may be necessary, the object updating device 29 provides or creates an engineering environment EE1 in the first server 12, step 32, in which environment EE1 may be isolated from the production environment PE. In this manner, two environments that are related to each other may be provided. Although the discussion herein is in the context of one such engineering environment, mainly the at least one engineering environment EE1, as is evident from FIG. 3, there may be more engineering environments created. Thus, in some embodiments, a number of related environments may be provided where one is the production environment and the rest are engineering environments. The engineering environment EE1 may then be restricted, for instance by the object updating device 29, to a group of system-modifying users. Although a group of system-modifying users may be as small as one user, in some embodiments a group may include multiple users and may be as large as all system-modifying users associated with the system 10, i.e. all users allowed to modify the system 10. This means that the group of system-modifying users are associated with and may work on the engineering environment EE1 and all other system users may be barred from it. If the object updating device 29 receives a request to import original operative objects to the engineering environment EE1 from a user in the group of system-modifying users, step 34, such objects may be imported, step 36. Such a request may normally be sent to the object updating device 29 from one of the system-modifying users of the group via one of the engineering terminals 16. The importing may be done by copying the requested versions, which is exemplified in FIG. 4, which shows object pairs of the aspects asp 1, asp3, asp 4 and asp 5, such that one object in the pair belongs to the production environment PE and the other object in the pair belongs to the engineering environment EE1. Two objects asp 2 and asp6 are also shown as belonging to both the production environment PE and the engineering environment EE1. In some embodiments, the objects of the production environment may include a version number, which is illustrated as version number 1, ver. 1. Initially the copied objects may keep the same version number.

Once the objects have been imported, the group of system-modifying users may modify the copied objects, step 38, which may be done via one or more of the engineering terminals 16 of FIG. 1. As an object is being modified, a new version number may be created. For example, as shown in FIG. 4, the modified aspects that belong to the engineering environment EE1 have received a new version number, ver. 2. This version may only be visible within the engineering environment EE1. Thus, other users outside of the group may not see the object versions in the engineering environment EE1. Other users outside of the group may be prevented from modifying these object versions, i.e. they may not have access to the engineering environment EE1. In this way, only the type of system users intended to make modifications may be allowed to make them. In some embodiments, one of the system-modifying users of the group may reserve one or more objects in the engineering environment EE1, so that no other user in the group can modify the objects in question. This reservation may stay in place until the specific system-modifying user of the group releases it or until another user with privileges to do so breaks the reservation. Thus, the objects may be barred from being modified by users of the group other than the one making the reservation. In this manner, accidental changes by other users of the group may be avoided on work performed on objects by the specific user.

When the group is finished modifying, a user of the group may now request deployment of the object versions in the engineering environment EE1, step 40. A request may be sent to the object updating device 29 for exporting objects of the engineering environment to the production environment. In some embodiments, a the request may be directed towards replacing operative versions of objects in the production environment PE with new modified versions in the engineering environment EE1. However, if before operative versions are replaced, the object updating device 29 may check and/or investigate to determine if any of the operative object versions in the production environment PE have been updated, step 42. If the operative object versions have been updated, the group of system-modifying users may be informed of the updates, step 44. Informing the group of system-modifying users may be done by providing a difference report listing all the objects in the production environment PE that have been updated. A system-modifying user of the group may then decide if the updates are relevant for the versions of objects in the engineering environment EE1. The object updating device 29 may then investigate to determine if there is a request to import such updates, step 46. If there is no such request, the object versions in the engineering environment EE1 may be deployed, step 50. If there is a request to import updates, the updates are imported to the engineering environment, step 48, whereupon deployment may take place, step 50. When deploying the objects in the engineering environment, the operative versions in the production environment PE may be exchanged with the modified versions in the engineering environment EE1, which are then used in the production environment as new operative versions. In this manner, a log of the versions including when they were operative and not operative may be kept.

In some embodiments, a modified version in the engineering environment can be a non-existent version. For example, the copied version of an object may be deleted when it is modified. This deleted object may not be provided with a version number, and the operative object may be deleted in the replacing step, as discussed above. In some embodiments, updating may limit reporting the updates to the objects that have been imported to the engineering environment EE1.

In some embodiments, the group of system-modifying users may create new objects in the engineering environment that do not previously exist in the production environment. Such objects may receive a version number, which normally is version number 1, and may be deployed together with the rest of the objects of the engineering environment. In this manner, the production environment could thus also receive a new object in addition to modified and/or deleted objects.

In some embodiments, it is possible to import versions of objects to an engineering environment from another engineering environment instead of from the production environment and then also check for updates in that other engineering environment. For example, the at least one engineering environment EE1 may be created first, followed by the creation of the second engineering environment EE2 shown in FIG. 3. In this case, the at least one engineering environment EE1 may receive copies of objects from the production environment PE, while the second engineering environment EE2 may receive versions of objects from the production environment PE and/or from the at least one engineering environment EE1. Some embodiments may deploy and/or export objects to another engineering environment. For example, the at least one engineering environment may export objects to the second engineering environment. In this case the exporting or deploying may involve replacing current versions of objects in the related second engineering environment with modified versions from the at least one engineering environment. Objects may thus be imported to an engineering environment from any related environment and objects may also be exported from this engineering environment to any related environment. It is furthermore possible to omit the check of updates in the environment from where objects are imported. In some embodiments, a system-modifying user of the group may check for updates on his own initiative before being ready to deploy the objects of an engineering environment. A reservation, as discussed above, may be made for more than one user in the group.

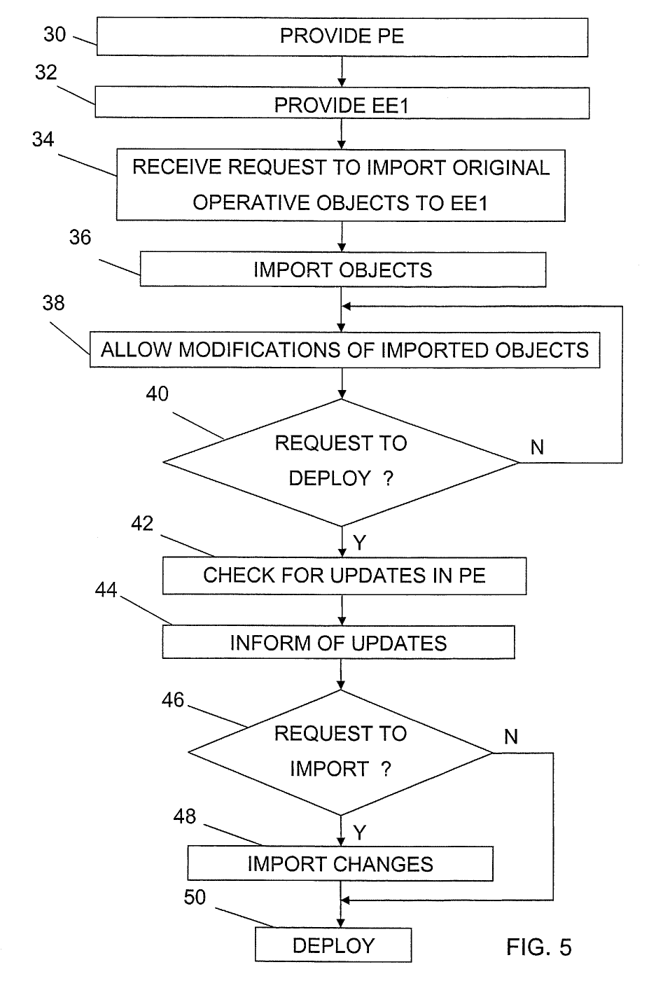

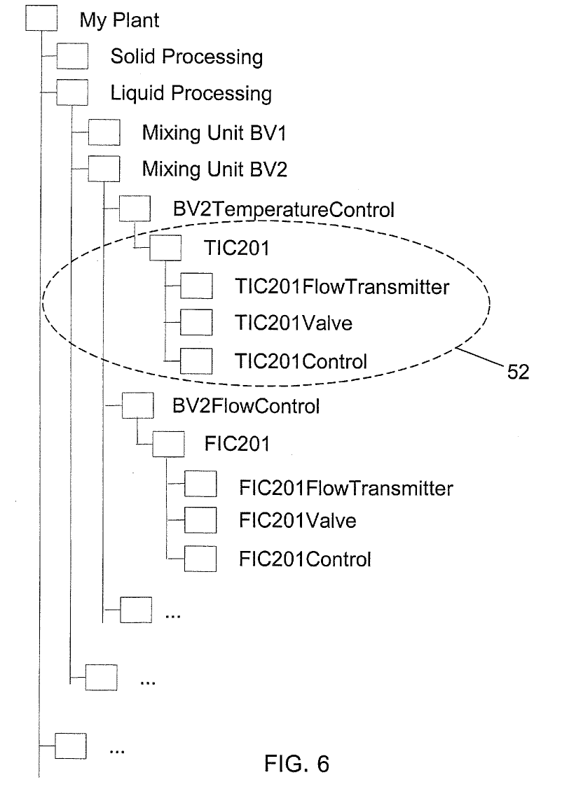

Objects may be organized in hierarchical structures, as shown in FIG. 6. For example, FIG. 6 shows a number of objects where a first highest level is named My Plant. In a second level there are two objects named Solid Processing and Liquid Processing, both linked to the object My Plant. In a third level there are also two objects named Mixing Unit BV1 and Mixing Unit BV2 linked to the object named Liquid Processing. In a fourth level there are provided two objects BV2Temperature Control and BV2FlowControl, both linked to the object Mixing Unit BV2. In a fifth level there are provided two objects TIC201 and FIC201, such that the object named TIC201 is linked to the object BV2TemperatureControl and the object FIC201 is linked to the object BV2FlowControl. In a sixth level there are provided objects named TIC201FlowTransmitter, TIC201Valve and TIC201Control all linked to the object TIC201, such that these objects TIC201FlowTransmitter, TIC201Valve, TIC201Control and TIC201 are shown as a substructure 52. In the sixth level there are finally provided objects named FIC201FlowTransmitter, FIC201Valve and FIC201 Control, which are all linked to the object FIC201. These objects are shown as a substructure 52. These objects may be related to the real world object in the process section of FIG. 1.

Some embodiments of the invention may include dependencies in a collection of objects, such that the dependencies are of such nature that the objects must always be provided together as an entity. An example of such a collection of objects or entity is the substructure 52 shown in FIG. 6, in which the objects TIC201FlowTransmitter, TIC201 Valve and TIC201 Control are all included in the object TIC201. Such a collection of objects may be defined to be handled by the object updating device as one entity. In this manner, if an object in such a collection is imported to an engineering environment, all of the objects in the collection are imported. Likewise, when an object in such a collection is deployed to the production environment, the whole collection is deployed and the corresponding collection in the production environment may be replaced in its entirety. In some embodiments, such collections may be nested, i.e. that one collection may include another collection. Such collections, however, are not limited to substructures in a hierarchical structure of objects, but can consist of any collection of objects.

Some embodiments may include relations between a first object and one or more second objects, where the relations are of such nature that the first object may not function properly without the presence of the correct version of the one or more second objects. In such cases, the group of system-modifying users of an engineering environment may be notified about other objects that are related to an object to be imported or deployed, and then a user in the group of system-modifying users may decide whether or not also related objects are to be imported to or deployed from this engineering environment. This is because there may be different degrees of relationships where changes on an object are more or less serious to related objects. The system may also enforce the inclusion of such related objects, e.g. for particularly strong relations.

As illustrated in FIG. 4, the different versions of objects may be in the described embodiment provided together in the first server 12, such that each version of an object may be provided with an indication as to which environment it belongs. Thus, data specifying to which environment the different versions of objects on the first server belong is provided by providing such indications. In some embodiments, lists may be used instead. For example, one list per environment may be used, where each list includes the versions associated with the environment to which the list refers. In some embodiments, one or more central lists may be provided, such that all environments are indicated in addition to versions of objects belonging to the different environments. Other embodiments may include other arrangements of cross-references between versions and/or environments.

Embodiments of the present invention may provide a number of advantages. For example, an object may be updated in a safe and contained way that may not disturb the process. Furthermore, an engineering environment may be small, so that it may only include the objects that need to be changed or are influenced by changes. Thus, there may be no need for copying all the objects of the production environment. In this manner, additional system requirements, such as memory space for the engineering environments, can be reduced. Some embodiments may allow several versions of computer objects to exist simultaneously and/or allow the definition of different contexts to describe which version of each object is used for production and which is being changed. Some embodiments may provide a mechanism by which versions of objects can be formally moved between these contexts, which may provide good safety when updating.

In some embodiments of the, present invention several modifications can be made in addition to those previous to discussed. In some embodiments, for example, the client application can be provided in a client terminal. In some embodiments, the different environments may be kept on different entities in the system. For example, different environments may be kept on separate servers. Although regarding embodiments discussed above, the object updating device served to restrict an engineering environment to a group of system-modifying users, embodiments may also utilize other means of providing this restriction. For example the restriction may be provided using the access control functions of the system.

Although in some embodiments the object updating device is shown as being provided in the first server, it can be implemented through one or more processors together with computer program code for performing its functions. It should be realized that the object updating device may be provided in other entities of the system, for example, the object updating device may be provided in the second server, a separate computer on the network, and/or in an engineering terminal. In some embodiments, the program code may also be provided as a computer program product, for an example in the form of one or more data carriers carrying computer program code for performing the functionality of the present invention when being loaded into a server. One such carrier 54, in the form of a CD ROM disc is generally outlined in FIG. 7. In some embodiments, the computer program code may utilize other data carriers. The computer program code can furthermore be provided as pure program code on a server and/or downloaded to the first system.

Although the present invention has been described in terms of specific embodiments, the present invention is not intended to be limited by the embodiments described herein. Thus, the scope may be determined by the following claims.

1. A method of updating objects in an object-based computerized system, comprising:
providing a related environment within the system comprising operative versions of computer objects, where at least some of the objects are used for control of real world objects in the process;
providing at least one engineering environment within the system, the engineering environment being isolated from the related environment;
receiving a request from a system-modifying user in a group of system-modifying users associated with the at least one engineering environment, to import selected versions of at least some objects to the at least one engineering environment from the related environment;
importing the selected versions to the at least one engineering environment;
allowing the group to modify the imported objects for creating modified versions of these objects and barring other users from modifying the imported objects;
receiving a request from a system-modifying user of the group to export objects of the at least one engineering environment to the related environment after modification of the imported objects is finished; and
exporting objects to the related environment responsive to the request, wherein the exporting the objects includes replacing current versions of objects in the related environment with modified versions from the at least one engineering environment, for making the modified versions the current versions.

2. The method according to claim 1, further comprising:
at least once investigating, after the provision of the at least one engineering environment, updates that have been made of versions of objects in the related environment from which versions of objects are imported;
informing a system-modifying user of the group of updates made, at least regarding objects that have been imported to the at least one engineering environment;
receiving a request from this system-modifying user to import such updated versions of objects to the at least one engineering environment; and
importing the requested updated versions to the at least one engineering environment, all done before exporting objects to the related environment.

3. The method according to claim 1, wherein the related environment from which versions of objects are imported is the production environment and imported versions of objects are the operative versions of objects of the production environment.

4. The method according to claim 1, wherein the related environment from which versions of objects are imported is at least another engineering environment.

5. The method according to claim 1, wherein the related environment to which versions of objects are exported is the production environment and the current versions of objects are the operative versions of objects of the production environment.

6. The method according to claim 1, wherein the related environment to which versions of objects are exported is at least another engineering environment.

7. The method according to claim 1, wherein the objects are provided in collections, where a collection includes objects that have dependencies of each other.

8. The method according to claim 7, wherein a collection comprises a hierarchical structure of objects.

9. The method according to claim 7, wherein the step of importing objects comprises importing at least one whole collection to the at least one engineering environment and the replacing of current versions of objects in the related environment with modified versions from the at least one engineering environment comprises replacing a whole collection of objects.

10. The method according to claim 1, further comprising informing the system-modifying user requesting to import a first object to the at least one engineering environment or the system-modifying user requesting to export a first object to the related environment of other objects related to the first object, and in dependence of the reception of a request to add at least one of the other objects to the first object from this system-modifying user, importing or exporting also this at least one other object.

11. The method according to claim 1, wherein the group of system-modifying users includes more than one system-modifying user and further comprising receiving a request, from one system-modifying user of the group, to reserve at least some objects of the at least one engineering environment for modifying to a limited number of system-modifying users of the group and barring these objects from being modified by other system-modifying users.

12. The method according to claim 1, wherein objects are organized into containers and aspects, wherein each aspect is linked to one container and at least one aspect is linked to each container, wherein containers represent real world objects and aspects represent facets of the real world objects, and wherein aspects provide data and/or operations related to the facets of the real world objects.

13. The method according to claim 1, wherein allowing the modifying of an object comprises allowing the deletion of an object and replacing comprises deleting also the current version of this object.

14. The method according to claim 1, wherein allowing the modifying of an object comprises allowing the changing of an object for providing a modified version and the replacing comprises replacing the current version with the modified version.

15. The method according to claim 1, further comprising allowing the group of system-modifying users to create new objects in the at least one engineering environment and barring other users from modifying the created objects, wherein exporting objects includes exporting also these new objects to the related environment.

16. The method according to claim 1, wherein the versions of objects of the operative environment and the at least one engineering environment are provided together and the system includes data specifying to which environment each version belongs.

17. The method according to claim 16, wherein each version is provided with an indication of the environment to which it belongs.

18. The method according to claim 16, wherein there is provided at least one list in the system providing information of to which environment each version belongs.

19. The method according to claim 18, wherein each environment is provided with a list listing the versions of objects belonging to this environment.

20. The method according to claim 18, wherein there is at least one central list in the system providing information regarding all environments and the versions belonging to each environment.

21. An object updating device that updates objects in an object-based computerized system that is configured to control real world objects, the device configured to:
provide a production environment within the system comprising operative versions of computer objects wherein at least some of the objects are used for control of real world objects in the process;
provide at least one engineering environment within the system, wherein the engineering environment is isolated from the production environment;
receive a request from a system-modifying user in a group of system-modifying users associated with the at least one engineering environment to import selected versions of at least some objects to the at least one engineering environment from a related environment;
import the selected versions to the at least one engineering environment, wherein the group is allowed to modify the imported objects for creating modified versions of these objects and other users are barred from modifying the imported objects;
receive a request from a system-modifying user of the group to export objects of the at least one engineering environment to a related environment after modification of the imported objects is finished; and
export objects to the related environment according to the request, wherein exporting the objects includes replacing current versions of the objects in the related environment with modified versions from the at least one engineering environment, for making the modified versions the current versions.

22. The object updating device according to claim 21, further configured to:
investigate, after the provision of the at least one engineering environment, updates that have been made of versions of the objects in the related environment from which versions of the objects are imported;
inform a system-modifying user of the group of updates made, regarding objects that have been imported to the at least one engineering environment;
receive a request from this system-modifying user to import the updated versions of objects to the at least one engineering environment; and
import the requested updated versions of objects to the at least one engineering environment before exporting the objects to the related environment.

23. The object updating device according to claim 21, wherein the related environment from which versions of objects are imported comprises the production environment and imported versions of objects comprise operative versions of objects of the production environment.

24. The object updating device according to claim 21, wherein the related environment from which versions of objects are imported comprises at least another engineering environment.

25. The object updating device according to claim 21, wherein the related environment to which versions of objects are exported comprises the production environment and the current versions of objects comprise the operative versions of objects of the production environment.

26. The object updating device according to claim 21, wherein the related environment to which versions of objects are exported comprises at least another engineering environment.

27. The object updating device according to claim 21, wherein the objects are provided in collections, wherein a collection comprises objects that have dependencies of each other.

28. The object updating device according to claim 27, wherein a collection comprises a hierarchical structure of objects.

29. The object updating device according to claim 28, wherein importing objects comprises importing at least one whole collection to the at least one engineering environment and replacing current versions comprises replacing a whole collection of objects.

30. The object updating device according to claim 21, further configured to:
inform the system-modifying user requesting to import a first object to the at least one engineering environment or the system-modifying user requesting to export a first object to the related environment of other objects related to the first object;
add, responsive to the reception of a request from the system-modifying user, at least one of the other objects to the first object; and
import or export the at least one other object.

31. The object updating device according to claim 21, wherein the group of system-modifying users comprises more than one system-modifying user and the device is further configured to:
receive a request, from one system-modifying user of the group; and
reserve at least some objects of the at least one engineering environment for modifying to a limited number of system-modifying users of the group and to bar these objects from being modified by other system-modifying users.

32. The object updating device according to claim 21, wherein objects are organized into containers and aspects, wherein each aspect is linked to one container and at least one aspect is linked to each container, wherein containers represent real world objects and aspects represent facets of the real world objects, and wherein aspects provide data and/or operations related to the facets of the real world objects.

33. The object updating device according to claim 21, further configured to allow the deletion of an object when configured to allow modifying of an object and to delete the current version of this object when configured to replace a current version of this object in the related environment.

34. The object updating device according to claim 21, further configured to allow the changing of an object for providing a modified version when configured to allow modifying of an object and to replace the current version with the modified version when configured to replace a current version of an object in the related environment.

35. The object updating device according claim 21, wherein the group of system-modifying users is allowed to create new objects in the at least one engineering environment and other users are barred from modifying the created objects, wherein the object updating device is further configured to export also these new objects to the related environment when configured to export objects.

36. The object updating device according to claim 21, wherein the versions of objects of the operative environment and the engineering environment are provided together and the system comprises data specifying to which environment each version belongs.

37. The object updating device according to claim 36, wherein each version is provided with an indication of the environment to which it belongs.

38. The object updating device according to claim 36, wherein the system includes at least one list configured to provide information corresponding to which environment each version belongs.

39. The object updating device according claim 38, wherein each environment comprises a list configured to list the versions of objects that belong to the environment.

40. The object updating device according to claim 38, wherein at least one central list in the system comprises information regarding all environments and the versions belonging to each environment.

41. An object based computerized system for process and manufacturing control configured to control real world objects, comprising:
at least one server; and
an object updating device configured to allow safe updating of objects being arranged to provide a production environment on at least one of the servers, the device comprising operative versions of computer objects wherein at least some are used for control of real world objects in the process;
wherein the object updating device is further configured to
provide at least one engineering environment on the at least one of the servers, wherein the engineering environment is isolated from the production environment, in order to provide a number of related environments including the production environment and all engineering environments,
receive a request, from a system-modifying user in a group of system-modifying users associated with a at least one engineering environment, to import versions of at least some objects to the engineering environment from a related environment, wherein the group includes at least one system-modifying user,
import the selected versions to the at least one engineering environment, wherein the group is allowed to modify the imported objects for creating modified versions of these objects and other users are barred from modifying the imported objects,
receive a request, from a system-modifying user of the group, to export objects of the at least one engineering environment to a related environment after modification of the imported objects is finished, and
export objects to the related environment according to the request, wherein exporting comprises replacing current versions of objects in the related environment with modified versions from the at least one engineering environment, for making the modified versions current versions.

42. A computer program product configured to allow safe updating of objects in an object-based computerized system for process and manufacturing control configured to control real world objects, the computer program product comprising computer program code to make at least one computer perform when the code is loaded into the at least one computer:
provide a production environment within the system comprising operative versions of computer objects, wherein at least some are used for control of real world objects in the process;
provide at least one engineering environment within the system, wherein the engineering environment is isolated from the production environment, in order to provide a number of related environments including the production environment and all engineering environments;
receive a request, from a system-modifying user in a group of system-modifying users associated with a at least one engineering environment, to import versions of at least some objects to the engineering environment from a related environment, wherein the group includes at least one system-modifying user;
import the selected versions to the at least one engineering environment, wherein the group is allowed to modify the imported objects for creating modified versions of the objects and other users are barred from modifying the imported objects;
receive a request, from a system-modifying user of the group, to export objects of the at least one engineering environment to a related environment after modification of the imported objects is finished; and
export objects to the related environment according to the request, wherein exporting comprises replacing current versions of objects in the related environment with modified versions from the at least one engineering environment, configured to make the modified versions the current versions.
